(19) United States
(12) Patent Application Publication
(10) Pub. No.: US 2012/0074069 A1
(43) Pub. Date: Mar. 29, 2012

(54) SMART FILTER MONITOR

(75) Inventors: David L. Ripley, San Diego, CA (US); Brian E. Hemesath, San Diego, CA (US)

(73) Assignee: HANILTON SUNDSTRAND CORPORATION, Windsor Locks, CT (US)

(21) Appl. No.: 12/838,953

(22) Filed: Jul. 19, 2010

(51) Int. Cl. B01D 35/143; G01N 11/02; B01D 35/147

(52) U.S. Cl. 210/741; 210/86; 210/808; 210/90; 210/87; 73/54.02

(57) ABSTRACT

An enhanced system for monitoring clogging of a fluid filter. A differential pressure sensor connects to fluid lines on opposite sides of the filter to measure a pressure difference across the filter. A viscosity-indicating property sensor connects to one of the fluid lines to measure a viscosity-indicating property of the fluid. A filter monitor in communication with the differential pressure sensor and the viscosity-indicating property sensor issues an operator alert when the pressure difference across the filter exceeds a differential pressure set point. The differential pressure set point is a function of the viscosity-indicating property of the fluid in the fluid line. In one embodiment, a fluid flow rate device in communication with the filter monitor indicates a flow rate of the fluid through the filter. The differential pressure set point is additionally a function of the flow rate of fluid through the filter.

### STATEMENT OF GOVERNMENT INTEREST

The U.S. Government has a paid-up license in this invention and the right in limited circumstances to require the patent owner to license others on reasonable terms as provided for by the terms of Contract No. N00019-06-C-0081, Sub-Contract No. 4500019224 awarded by the United States Navy.

### BACKGROUND

The present invention relates to fluid filter systems. In particular, the invention relates to a fluid filter monitoring system.

Fluid systems, such as, for example, for delivering fuel or oil to an engine, typically contain a filter to remove contaminants from the fluid. More advanced fluid systems also have a system for monitoring the extent to which a filter is clogged to alert an operator to change the filter before a flow rate through the filter becomes insufficient for the application. In critical applications, such as, for example, in aircraft fuel systems, fuel must keep flowing to an engine to maintain flight or provide power for the aircraft. When a filter becomes sufficiently clogged as to threaten an adequate flow rate of fuel, a bypass valve activates, permitting fuel to bypass the filter. While this keeps the aircraft in flight, damage to the engine may occur from contaminants in the unfiltered fuel. The purpose of a filter monitoring system is to alert an operator to change a filter before the flow rate through the filter becomes insufficient for the application or before activation of the bypass valve.

A typical filter monitoring system measures a differential pressure across a filter to indicate the extent to which a filter is clogged. Once a differential pressure set point is reached, the filter monitoring system alerts an operator that the filter needs to be changed. The differential pressure set point is typically set well below a differential pressure that would indicate insufficient flow rate through the filter for the application or trigger activation of a bypass valve.

### SUMMARY

One embodiment of the present invention includes a system for monitoring clogging of a fluid filter. A differential pressure sensor is connected to fluid lines on opposite sides of the filter to measure a pressure difference across the filter. A viscosity-indicating property sensor is connected to one of the fluid lines to measure a viscosity-indicating property of the fluid. A filter monitor in communication with the differential pressure sensor and the viscosity-indicating property sensor issues an operator alert when the pressure difference across the filter exceeds a differential pressure set point. The differential pressure set point is a function of the viscosity-indicating property of the fluid in the fluid line.

### BRIEF DESCRIPTION OF THE DRAWINGS

FIG. 1 is a general schematic view of a first embodiment of a smart filter monitor of the present invention.

FIG. 2 is a general schematic view of a second embodiment of a smart filter monitor of the present invention.

FIG. 3 is a general schematic view of a third embodiment of a smart filter monitor of the present invention.

FIG. 4 is a graph illustrating a relationship between differential pressure set point as a function of flow rate and a viscosity-indicating property.

### DETAILED DESCRIPTION

Fluid filter monitoring systems typically use a fixed differential pressure set point (DPSP) to alert an operator to replace the fluid filter. The fixed DPSP is set lower than a differential pressure that would indicate insufficient flow rate through the filter for the application, or trigger activation of a bypass valve, to allow for a delay in changing the fluid filter due to, for example, the need to fly an aircraft to a service location, obtain a filter, or schedule a time for replacement.

While a fixed DPSP may be adequate under conditions where the temperature of the filtered fluid is constant, under conditions where the fluid temperature is not constant a fixed DPSP is inadequate. A fixed DPSP may result in premature replacement of the fluid filter due to the additional differential pressure drop across a filter resulting from the increase in viscosity of the fluid at lower temperatures. The viscosity of the vast majority of fluids in critical applications, for example, fuel and oil, increase with decreasing temperature over typical operating temperatures. For example, a partially clogged fuel filter for an engine may have a differential pressure across the filter well below the fixed DPSP when the engine is warmed up and operating normally, but exceed the fixed DPSP at start up, when the engine, and the fuel, are cold. Thus, at cold engine start up, an operator is alerted to replace the fluid filter before replacement is actually required.

Some filter monitoring systems employ a thermal lockout that prevents an alert from issuing when the fluid temperature is cold. While this does help prevent unnecessary filter changes, it creates a potentially more serious problem by permitting operation under conditions of inadequate fluid flow or bypass activation. Operation with insufficient lubricating oil or unfiltered fluids until the fluid temperature rises sufficiently to deactivate the thermal lockout will damage a device relying on adequate fluid flow or filtered fluids.

The present invention extends fluid filter life by employing a variable DPSP. The DPSP is varied as a function of a viscosity-indicating property, such as fluid temperature. A variable DPSP eliminates premature filter replacement that occurs during, for example, a cold engine start up, by increasing the DPSP to account for a known, predictable increase in differential pressure across the fluid filter due solely to a known, predictable increase in viscosity of the fluid at a lower temperature. By varying the DPSP as a function of fluid temperature, no alert is triggered due to an additional differential pressure caused solely by a lower fluid temperature. Upward adjustment on the variable DPSP is limited to a differential pressure that would indicate insufficient flow through the filter for the application or trigger activation of a bypass valve. This ensures adequate fluid flow through the filter even under cold start up conditions, preventing the type of damage that can occur on conventional systems, such as those employing thermal lockouts.

In addition, the present invention protects a device that relies on an adequate fluid flow rate or a fluid flow free from contaminants, for example, an engine, by providing alerts throughout the range of fluid temperatures for the device. For example, a flight maintenance crew will often begin extensive maintenance activities in the morning when the aircraft and its fluids are cold. By alerting the maintenance crew to the need for filter replacement early in the maintenance activity, before warming up the engine the filter can be replaced before proceeding with other maintenance and checkout activities, many of which would otherwise have to be repeated if the filter were changed out later in the maintenance activity when the fluids warmed up.

The present invention also alerts an operator when a differential pressure at warmer, operating temperatures is sufficient, when adjusted for a cold start temperature, to exceed the differential pressure that would trigger activation of a bypass valve at the cold start temperature. Once alerted, the operator would replace the filter before the next cold start up, eliminating activation of the bypass valve at the next cold start up, and reducing damage to the engine from contaminants in the unfiltered fluid.

Finally, an embodiment of the present invention alerts an operator when a differential pressure at a lower flow rate is sufficient, when adjusted for a higher flow rate and for fluid viscosity, to exceed the differential pressure that would trigger activation of a bypass valve at the higher flow rate and higher viscosity. Once alerted, the operator would avoid conditions requiring the high flow rate, if possible, and replace the filter at the next opportunity.

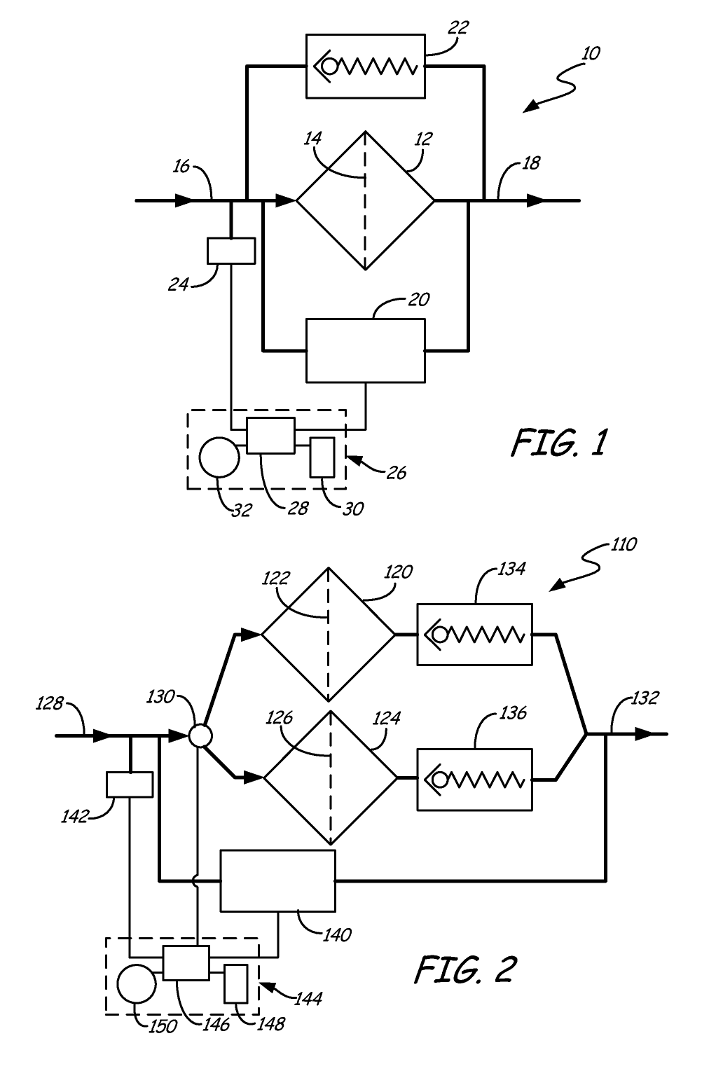

FIG. 1 is a general schematic view of a first embodiment of a smart filter monitor of the present invention. For clarity, fluid connection lines are illustrated as wider lines compared to electrical connection lines. FIG. 1 shows fluid filtering system 10, including filter housing 12, filter medium 14, filter input line 16, filter output line 18, differential pressure sensor 20, bypass valve 22, viscosity-indicating property sensor 24, and filter monitor 26. Filter monitor 26 comprises controller 28, memory 30, and indicator 32. Differential pressure sensor 20 is, for example, a single differential pressure transducer sensitive to the difference between two input pressures or two separate pressure transducers, each sensitive to a single input pressure. Bypass valve 22 is a normally closed valve that opens only when a pressure difference across it exceeds a predetermined bypass valve pressure. Viscosity-indicating property sensor 24 is any sensor whose output can be used to indicate changes in viscosity, for example, a temperature sensor or an acoustic wave sensor. Controller 28 is any type of electronic controller that can accept electrical inputs, process the electrical inputs according to instructions, and produce electrical outputs in response to the inputs, for example, a microprocessor or a programmable logic device. Memory 30 is any of the various memory storage devices that maintain stored data values even if power is no longer applied, for example, electrically erasable programmable read-only memory (EEPROM) and flash memory. Memory 30 contains a relationship between a viscosity-indicating property measurement and a DPSP corresponding to the viscosity-indicating property measurement. This relationship may be of any of several forms including, for example, an equation or a look-up table. Indicator 32 is any device for indicating the output of controller 28, for example a signal lamp, a message display such as an LCD screen, an audio signal, a digital communication bus leading to a remote display, or a discrete, analog or digital output to an external controller (not shown).

As shown in FIG. 1, filter housing 12 contains filter medium 14 and connects filter input line 16 to filter output line 18. Differential pressure sensor 20 connects to filter input line 16 and filter output line 18. Bypass valve 22 also connects to filter input line 16 and filter output line 18. Viscosity-indicating property sensor 24 connects to filter input line 16. Differential pressure sensor 20 and viscosity-indicating property sensor 24 are electrically connected to controller 28 of filter monitor 26. Controller 28 is electrically connected to memory 30 and indicator 32. As mentioned above, indicator 32 may be, for example, a digital communication bus connected to a remote display, such as a flight panel display in an aircraft cockpit and may include both a visual indication and an audio indication.

In operation, unfiltered fluid enters fluid filtering system 10 at filter input line 16 and flows into filter housing 12 where it is filtered by filter medium 14. Filtered fluid exits filter housing 12 and flows into filter output line 18 where it exits fluid filtering system 10. As with any fluid filter, a pressure difference exists across filter medium 14 and acts as a driving force to move the fluid through filter medium 14. As filter medium 14 becomes clogged with filtered residues, the pressure difference across filter medium 14 must increase to maintain a desired flow rate through fluid filtering system 10. Before the pressure difference across filter medium 14 becomes high enough that the integrity of filter medium 14 may be damaged, the predetermined bypass valve pressure is reached, causing bypass valve 22 to open, permitting unfiltered fluid to flow into filter output line 18.

In order to alert an operator to a filter clogging problem before reaching the bypass valve pressure, the pressure difference across filter medium 14 is monitored. The pressure difference is measured by differential pressure sensor 20 which compares the pressure in filter input line 16 with the pressure in filter output line 18. Differential pressure sensor 20 electrically transmits this measurement to controller 28. The comparison is either direct, with a single differential transducer responding to the pressure difference, or indirect, with two transducers taking two pressure measurements and controller 28 subtracting the two pressure measurements to determine the pressure difference across filter medium 14. Viscosity-indicating property sensor 24 measures a property indicative of viscosity, for example, a fluid temperature, in filter input line 16 and electrically transmits this measurement to controller 28. Controller 28 employs the measurement received from viscosity-indicating property sensor 24 to obtain a variable DPSP from memory 30 corresponding to the viscosity-indicating property measurement. Controller 28 compares the variable DPSP to the measurement received from differential pressure sensor 20 and issues an alert to indicator 32 once the measurement received from differential pressure sensor 20 exceeds the variable DPSP.

The variable DPSP is always below the bypass valve pressure, ensuring that the operator will be alerted to filter clogging before bypass valve 22 activates and sends unfiltered fluid out of fluid filtering system 10. The variable DPSP is available throughout the operating range of fluid filtering system 10, ensuring that alerts are issued under all conditions. For example, should fluid filtering system 10 be employed under cold conditions, for example, a cold engine start, the variable DPSP ensures an alert is issued quickly, preventing activation of bypass valve 22 and providing maintenance crews an opportunity to replace filter medium 14 before continuing with the remaining maintenance and checkout activities. This crucial time is not merely ignored, as would be the case with a fixed DPSP and a thermal lockout.

The relationship information between a viscosity-indicating property measurement and a DPSP corresponding to the viscosity-indicating property measurement contained in memory 30 permits controller 28 to alert an operator to a possible future cold start activation of bypass valve 22. Under conditions where the fluid is at warmer operating conditions and filter medium 14 becomes clogged with filtered residues, the measurement of differential pressure across filter housing 12 may be well below the differential pressure necessary to activate bypass valve 22. With the present invention, because the variable DPSP is determined by the relationship between the viscosity-indicating property throughout the operating temperature range, the variable DPSP under warmer operating conditions corresponds to the same condition of filter medium 14 under cold start conditions, where the variable DPSP might approach the differential pressure necessary to activate bypass valve 22. Thus, the variable DPSP at warmer temperatures would serve to alert the operator of possible activation of bypass valve 22 under cold start conditions. This allows the operator to arrange for filter replacement before the next cold start, preventing activation of bypass valve 22 and passage of unfiltered fluid out of fluid filtering system 10.

The present invention eliminates premature filter replacement that might be triggered in a conventional monitoring system during cold start up by varying the DPSP as a function of a viscosity-indicating property, such as temperature. More efficient filter use permits the use of a smaller filter and filter housing for a prescribed filter application lifetime. A smaller filter and filter housing reduces weight—an important benefit in weight-sensitive applications, such as aircraft.

FIG. 1 illustrates the present invention for applications employing bypass valve 22. However, the present invention applies equally well for applications without bypass valve 22, where instead the problems to be avoided include filter breakthrough from too high a differential pressure across filter medium 14 or, where the maximum available pressure is less than that necessary to cause failure of filter medium 14, insufficient fluid flow through fluid filtering system 10.

The embodiment illustrated in FIG. 1 employing a single filter housing 12 and bypass valve 22 is particularly useful for applications where fluid delivery reliability and weight are primary considerations, such as for fuel filtering in an aircraft engine. In contrast, the embodiment of a smart filter monitor of the present invention illustrated in FIG. 2 is particularly useful for industrial applications where fluid delivery reliability is important, but weight is not an important consideration. FIG. 2 illustrates a fluid filtering system employing the smart filter monitor of the present invention to automatically switch between two filter housings as part of issuing an operator alert. This permits continuous operation of the fluid filtering system, with all of the benefits described in reference to the previous embodiment.

FIG. 2 is a general schematic view of a second embodiment of a smart filter monitor of the present invention. FIG. 2 shows fluid filtering system 110, including first filter housing 120, first filter medium 122, second filter housing 124, second filter medium 126, filter input line 128, selector valve 130, filter output line 132, first backflow preventer 134, second backflow preventer 136, differential pressure sensor 140, viscosity-indicating property sensor 142, and filter monitor 144. Filter monitor 144 comprises controller 146, memory 148, and indicator 150. Selector valve 130 is any of various electrically controlled valves that direct flow from a line leading to selector valve 130 into one of two lines leading away from selector valve 130. Backflow preventers 134, 136 are valves that permit fluid flow only in one direction. Indicator 150 is any device for indicating the output of controller 146, for example a signal lamp, a message display such as an LCD screen, an audio signal, or a digital communication bus leading to a remote display or control system (not shown). All other components are as described above in reference to FIG. 1.

As shown in FIG. 2, first filter housing 120 contains first filter medium 122 and connects filter input line 128 to filter output line 132. First backflow preventer 134 is connected to the output of first filter housing 120 in a manner to prevent fluid from flowing from filter output line 132 into first filter housing 120. Second filter housing 124 contains second filter medium 126 and also connects filter input line 128 to filter output line 132. Second backflow preventer 136 is connected to the output of second filter housing 124 in a manner to prevent fluid from flowing from filter output line 132 into second filter housing 124. Selector valve 130 is connected to the inputs of both first filter housing 120 and second filter housing 124, such that it can direct the flow from filter input line 128 to either first filter housing 120 or second filter housing 124. Differential pressure sensor 140 connects to filter input line 128 and filter output line 132. Viscosity-indicating property sensor 142 connects to filter input line 128. Differential pressure sensor 140 and viscosity-indicating property sensor 142 are electrically connected to controller 146 of filter monitor 144. Controller 146 is electrically connected to selector valve 130, memory 148, and indicator 150.

In operation, unfiltered fluid enters fluid filtering system 110 at filter input line 128 and is directed by selector valve 130 into first filter housing 120 where it is filtered by first filter medium 122. Filtered fluid exits first filter housing 120 and flows through first backflow preventer 134 into filter output line 132 where it exits fluid filtering system 110. Second backflow preventer 136 prevents any flow of filtered fluid from filter output line 132 into second filter housing 124. As with any fluid filter, a pressure difference exists across first filter medium 122 and acts as a driving force to move the fluid through first filter medium 122. As first filter medium 122 becomes clogged with filtered residues, the pressure difference across first filter medium 122 must increase to maintain a desired flow rate through fluid filtering system 110. Before the pressure difference across first filter medium 122 becomes high enough that the integrity of first filter medium 122 may be damaged, selector valve 130 is directed by controller 146 to direct unfiltered fluid from filter input line 128 into second filter housing 124 where it is filtered by second filter medium 126. Filtered fluid exits second filter housing 124 and flows through second backflow preventer 136 into filter output line 132 where it exits fluid filtering system 110. First backflow preventer 134 prevents any flow of filtered fluid from filter output line 132 into first filter housing 120. With first filter housing 120 isolated by selector valve 130 and first backflow preventer 134, first filter medium 122 is replaced and ready to be employed when second filter medium 126 becomes clogged with filter residues and must be replaced. In this way, fluid filtering cycles back and forth between first filter housing 120 and second filter housing 124, with filter media 122 and 126 replaced accordingly.

In order to alert an operator to a filter clogging problem and automatically switch between first filter housing 120 and second filter housing 124 before reaching a pressure difference high enough to threaten the integrity of filter media 122 and 126 or reduce fluid flow through fluid filtering system 110 below a required flow rate, the pressure difference across the filter is monitored. The pressure difference is measured by differential pressure sensor 140 which compares the pressure in filter input line 128 with the pressure in filter output line 132. Differential pressure sensor 140 electrically transmits this measurement to controller 146. The comparison is either direct, with a single transducer responding to the pressure difference, or indirect, with two transducers taking two pressure measurements and controller 146 subtracting the two pressure measurements to determine the pressure difference across the filter medium in use, either first filter medium 122 or second filter medium 126. Viscosity-indicating property sensor 142 measures a property indicative of viscosity, for example, a fluid temperature, in filter input line 128 and electrically transmits this measurement to controller 146. Controller 146 employs the measurement received from viscosity-indicating property sensor 142 to obtain a variable DPSP from memory 148 corresponding to the viscosity-indicating property measurement. Controller 146 compares the variable DPSP to the measurement received from differential pressure sensor 140. Once the measurement from differential pressure sensor 140 exceeds the variable DPSP, controller 146 issues an alert to indicator 150 and automatically directs selector valve 130 to redirect unfiltered fluid flow from filter input line 128 to whichever of first filter housing 120 and second filter housing 124 is not in use.

The variable DPSP is always below the pressure difference high enough to threaten the integrity of filter media 122 and 126 or reduce fluid flow through fluid filtering system 110 below a required flow rate. This ensures that the operator will be alerted to filter clogging and filter housings will be switched before either filter media 122 and 126 fail and send unfiltered fluid out of fluid filtering system 110 or fluid flow through fluid filtering system 110 falls below the required rate. The variable DPSP is available throughout the operating range of fluid filtering system 110, ensuring that alerts are issued and filter housings automatically switched under all temperature conditions.

As with the embodiment of FIG. 1, this embodiment of the present invention extends fluid filter life by varying a DPSP as a function of a viscosity-indicating property, such as fluid temperature. Cold system start up is also enhanced with accurate fluid filter monitoring throughout the start up process.

While the embodiment of FIG. 2 is shown with two filters, it is understood that more than two filters may be employed in parallel, as may be required for a specific application. Different selector valve configurations may also be employed, for example, selector valve 130 may be a single valve directing flow to more than two lines leading away from selector valve 130 to support more than two filters. Alternatively, selector valve 130 may be two or more separate valves in parallel, opening and closing as coordinated by controller 146. Also, selector valve 130 may be controlled and actuated manually, electrically, hydraulically or pneumatically with a corresponding interface with controller 146. In addition, though not shown, it is also understood that a bypass valve, such as that described with reference to FIG. 1, or a pressure relief mechanism may be employed as desired for enhancing system safety and reliability. Also,

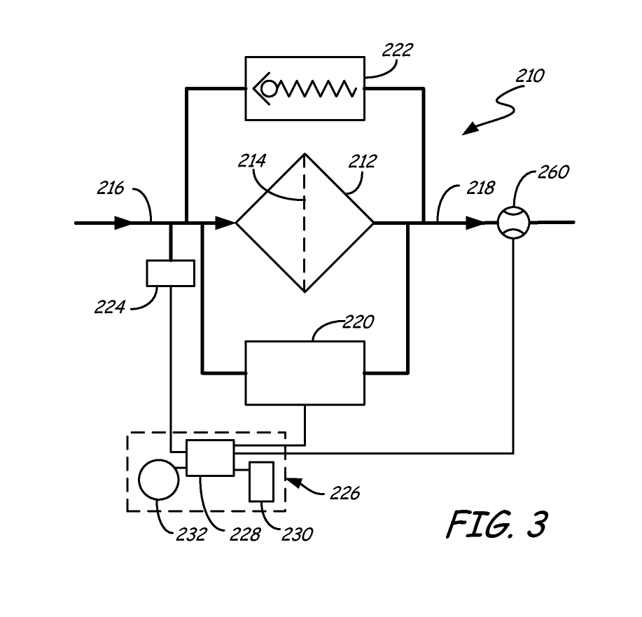

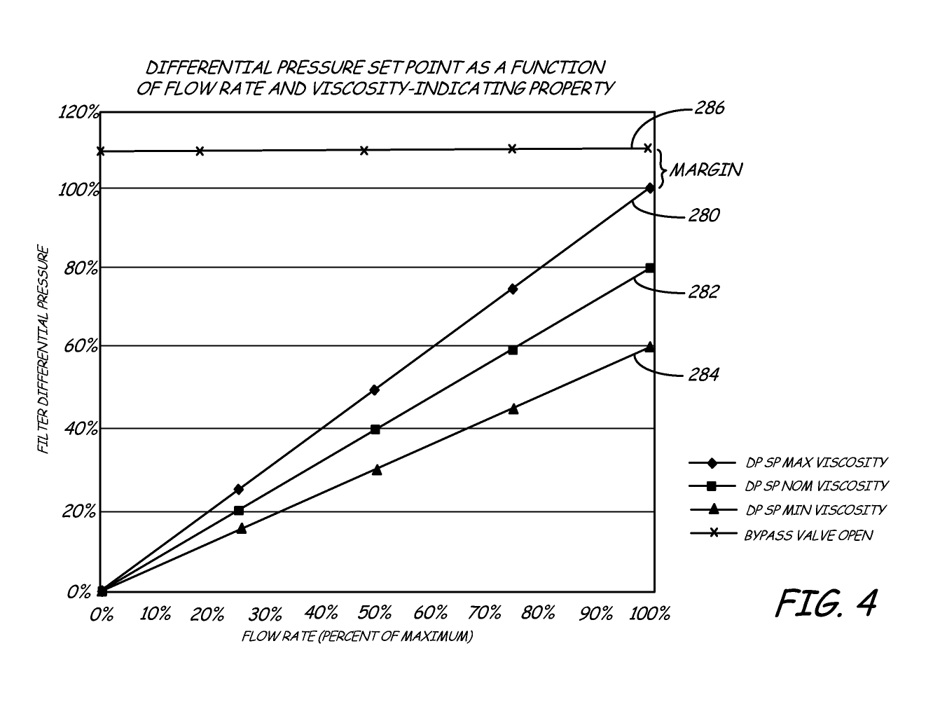

The previous embodiments of the present invention benefit greatly from the ability to vary the DPSP as a function of a viscosity-indicating property, such as fluid temperature. Additional benefits are gained by combining the ability to vary the DPSP as a function of a viscosity-indicating property with a capability to further adjust the variable DPSP as a function of a flow rate. FIG. 3 is a general schematic view of a third embodiment of a smart filter monitor of the present invention. The third embodiment is able to vary DPSP as a function of both a viscosity-indicating property and a flow rate. The embodiment in FIG. 3 is identical to that shown in FIG. 1 with component numbers increased by 200, except for the addition of flow meter 260. Flow meter 260 is any of a variety of fluid flow rate devices that determine a flow rate and provide an electrical output indicative of the flow rate. Flow meter 260 may be a flow meter that measures flow rate directly, for example, a differential pressure flow meter, an ultrasonic flow meter, or a turbine flow meter. Flow meter 260 may also be a calculated flow rate determined from indirect indications of flow, for example, a servo metering valve current or a fuel pump input signal. Flow meter 260 is electrically connected to controller 228.

In operation, unfiltered fluid enters fluid filtering system 210 at filter input line 216 and flows into filter housing 212 where it is filtered by filter medium 214. Filtered fluid exits filter housing 212 and flows into filter output line 218 where it exits fluid filtering system 210. As with any fluid filter, a pressure difference exists across filter medium 214 and acts as a driving force to move the fluid through filter medium 214. As filter medium 214 becomes clogged with filtered residues, the pressure difference across filter medium 214 must increase to maintain a desired flow rate through fluid filtering system 210. Before the pressure difference across filter medium 214 becomes high enough that the integrity of filter medium 214 may be damaged, the predetermined bypass valve pressure is reached, causing bypass valve 222 to open, permitting unfiltered fluid to flow into filter output line 218.

In order to alert an operator to a filter clogging problem before reaching the bypass valve pressure, the pressure difference across filter medium 214 is monitored. The pressure difference is measured by differential pressure sensor 220 which compares the pressure in filter input line 216 with the pressure in filter output line 218. The comparison is either direct, with a single differential transducer responding to the pressure difference, or indirect, with two transducers taking two pressure measurements and controller 228 subtracting the two pressure measurements to determine the pressure difference across filter medium 214. Viscosity-indicating property sensor 224 measures a property indicative of viscosity, for example, a fluid temperature, in filter input line 216 and electrically transmits this measurement to controller 228. Flow rate meter 260 determines a flow rate through fluid filtering system 210 and electrically transmits the flow rate to controller 228. Controller 228 employs the measurement received from viscosity-indicating property sensor 224 and the flow rate received from flow rate meter 260 to obtain a variable DPSP from memory 230 corresponding to the viscosity-indicating property measurement and the flow rate. Controller 228 compares the variable DPSP to the measurement received from differential pressure sensor 220 and issues an alert to indicator 232 once the measurement received from differential pressure sensor 220 exceeds the variable DPSP.

FIG. 4 illustrates a relationship between DPSP, flow rate and viscosity-indicating property stored in memory 230 as a series of tables or equations. FIG. 4 shows three lines of DPSP as a function of flow rate for a range of viscosities: maximum viscosity line 280, nominal viscosity line 282, and minimal viscosity line 284. Maximum viscosity line 280 corresponds to variable DPSP values under conditions of maximum viscosity, for example, at a minimum operational temperature. Similarly, minimum viscosity line 284 corresponds to variable DPSP values under conditions of minimum viscosity, for example, at a maximum operational temperature. Nominal viscosity line 282 corresponds to variable DPSP values under nominal conditions, for example, at a nominal operating temperature. In addition, FIG. 4 shows a constant differential pressure line corresponding to a differential pressure which would force open bypass valve 222, bypass valve open pressure 286. In accordance with the discussion above, a maximum value for DPSP occurring under conditions of maximum flow rate and at maximum viscosity, for example, during a cold engine start requiring maximum fuel flow rate for full engine loading, must still be below bypass valve open pressure 286 to provide an alert before triggering bypass valve 222. This margin is shown in FIG. 4 as the difference between maximum viscosity line 280 at a flow rate of 100%, designated as 100% filter differential pressure, and bypass valve open pressure 286 at 110% filter differential pressure. Although a 10% margin is illustrated, the margin can be any margin required for a specific filter monitoring application.

The previous embodiments of the present invention employ only variable DPSP values at 100% of flow rate. The embodiment described in reference to FIGS. 3 and 4 permits controller 228 to alert an operator to a possible future activation of bypass valve 222 under higher flow rate conditions, in addition to alerting under future higher viscosity conditions. For example, under conditions where the flow rate needed through the filter is less than 100% flow rate, for example, 50% flow rate, and filter medium 214 becomes clogged with filtered residues, the measurement of differential pressure across filter housing 212 may be well below not only the differential pressure necessary to activate bypass valve 222, but below the variable DPSP for the value of the viscosity-indicating property at 100% flow rate. With this embodiment of the present invention, because the variable DPSP is determined by the relationship between the viscosity-indicating property throughout the operating range of viscosities and the flow rate through fluid filter system 210, the variable DPSP at 50% flow rate corresponds to the same condition of filter medium 214 under 100% flow rate, where the variable DPSP, under conditions of maximum viscosity might approach bypass valve open pressure 286. Thus, the variable DPSP at a lower flow rate would serve to alert the operator of possible activation of bypass valve 222 under 100% flow rate and maximum viscosity conditions before 100% flow rate is required.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. For example, while the previous embodiments illustrate viscosity-indicating sensors connecting to filter input lines, they function equally well connecting to filter output lines. For another example, the margin described in reference to FIG. 4 could be set to achieve a process control objective other than indicating impending filter bypass, such as activating additional systems. Therefore, it is intended that the invention not be limited to the particular embodiment(s) disclosed, but that the invention will include all embodiments falling within the scope of the appended claims.

1. A system for monitoring clogging of a fluid filter, the system comprising:
a differential pressure sensor connected to fluid lines on opposite sides of the filter to measure a pressure difference across the filter;
a viscosity-indicating property sensor connected to one of the fluid lines on opposite sides of the filter to measure a viscosity-indicating property of fluid in the fluid line; and
a filter monitor in communication with the differential pressure sensor and in communication with the viscosity-indicating property sensor to permit the filter monitor to issue an operator alert when the pressure difference across the filter exceeds a differential pressure set point, wherein the differential pressure set point is a function of the viscosity-indicating property of the fluid in the fluid line.

2. The system of claim 1, wherein the viscosity-indicating property sensor comprises at least one of a temperature sensor and an acoustic wave sensor.

3. The system of claim 1, wherein the differential pressure sensor comprises a differential pressure transducer.

4. The system of claim 1, wherein the differential pressure sensor comprises:
a first pressure transducer connected to an upstream side of the filter; and
a second pressure transducer connected to a downstream side of the filter.

5. The system of claim 1, wherein the filter monitor further comprises:
a controller to issue the operator alert when the measured pressure difference across the filter exceeds the differential pressure set point for the measured viscosity-indicating property of the fluid; and
a memory device for providing the differential pressure set point to the controller, wherein the differential pressure set point is a function of the viscosity-indicating property of the fluid in the fluid line.

6. The system of claim 1, further comprising:
a fluid flow rate device in communication with the filter monitor to indicate a flow rate of the fluid through the filter; wherein the differential pressure set point is additionally a function of the flow rate of fluid through the filter.

7. The system of claim 6, wherein the fluid flow rate device comprises at least one of a differential pressure flow meter, an ultrasonic flow meter, a turbine flow meter, and a coriolis flow meter.

8. The system of claim 6, wherein the filter monitor further comprises:
a controller to issue the operator alert when the measured pressure difference across the filter exceeds the differential pressure set point for the measured viscosity-indicating property of the fluid; and
a memory device for providing the differential pressure set point to the controller, wherein the differential pressure set point is a function of the viscosity-indicating property of the fluid in the fluid line and as a function of the flow rate of fluid through the filter.

9. A method for filtering a fluid, the method comprising:
filtering a fluid with a first fluid filter;
measuring a viscosity-indicating property of the fluid;
reading from a memory device a differential pressure set point corresponding to the measured viscosity-indicating property;
measuring a differential pressure across the first fluid filter;
comparing the differential pressure to the differential pressure set point; and
signaling if the differential pressure exceeds the differential pressure set point.

10. The method of claim 9, wherein the viscosity-indicating property comprises at least one of viscosity and temperature.

11. The method of claim 9, wherein signaling comprises at least one of displaying a message; turning on a signal lamp, emitting an audible signal and transmitting a message to a control device.

12. The method of claim 9, further comprising:
directing the fluid away from the first fluid filter to a second fluid filter in response to the signal;
filtering the fluid with the second fluid filter;
measuring a viscosity-indicating property of the fluid;
reading from the memory device a differential pressure set point corresponding to the measured viscosity-indicating property;
measuring a differential pressure across the second fluid filter;
comparing the differential pressure across the second fluid filter to the differential pressure set point; and
signaling if the differential pressure across the second fluid filter exceeds the differential pressure set point.

13. A system for filtering a fluid, the system comprising:
a filter housing;
a filter medium within the filter housing;
a filter input line attached to the filter housing on one side of the filter medium for carrying unfiltered fluid to the filter housing;
a filter output line attached to the filter housing on the side of the filter medium opposite the filter input line for carrying filtered fluid out of the filter housing;
a differential pressure sensor connected to the filter input line and to the filter output line to measure a pressure difference across the filter housing;
a bypass valve connected to the filter input line and to the filter output line to permit passage of unfiltered fluid from the filter input line to the filter output line once the pressure difference across the filter housing exceeds a bypass valve pressure;
a viscosity-indicating property sensor connected to at least one of the filter input line and the filter output line to measure a viscosity-indicating property of the fluid; and
a filter monitor in communication with the differential pressure sensor and in communication with the viscosity-indicating property sensor to permit the filter monitor to issue an operator alert when the pressure difference across the filter exceeds a differential pressure set point, wherein the differential pressure set point is a function of the viscosity-indicating property of the fluid.

14. The system of claim 13, wherein the viscosity-indicating property sensor comprises at least one of a temperature sensor and an acoustic wave sensor.

15. The system of claim 13, wherein the differential pressure sensor comprises a differential pressure transducer.

16. The system of claim 13, wherein the differential pressure sensor comprises:
a first pressure transducer connected to the filter input line; and
a second pressure transducer connected to filter output line.

17. The system of claim 13, wherein the filter monitor comprises:
a controller to issue an operator alert when the measured pressure difference across the filter exceeds the differential pressure set point for the measured viscosity-indicating property of the fluid; and
a memory device for providing the differential pressure set point to the controller, wherein the differential pressure set point is a function of the viscosity-indicating property of the fluid in the fluid line.

18. The system of claim 13, further comprising:
a fluid flow rate device in communication with the filter monitor to indicate a flow rate of the fluid through the filter; wherein the differential pressure set point is additionally a function of the flow rate of fluid through the filter.

19. The system of claim 18, wherein the fluid flow rate device comprises at least one of a differential pressure flow meter, an ultrasonic flow meter, and a turbine flow meter.

20. The system of claim 18, wherein the filter monitor further comprises:
a controller to issue the operator alert when the measured pressure difference across the filter exceeds the differential pressure set point for the measured viscosity-indicating property of the fluid; and
a memory device for providing the differential pressure set point to the controller, wherein the differential pressure set point is a function of the viscosity-indicating property of the fluid in the fluid line and as a function of the flow rate of fluid through the filter.
